(19) United States
(12) Patent Application Publication
(10) Pub. No.: US 2022/0302683 A1
(43) Pub. Date: Sep. 22, 2022

(54) SPARK SYSTEM FOR IGNITERS

(71) Applicant: SAUDI ARABIAN OIL COMPANY, Dhahran (SA)

(72) Inventors: Khair Allah Sayer Al-Shammari, Al-Jubail (SA); Ahmed Ali Al-Ghamdi, Al-Dammam (SA)

(73) Assignee: SAUDI ARABIAN OIL COMPANY, Dhahran (SA)

(21) Appl. No.: 17/205,589

(22) Filed: Mar. 18, 2021

(51) Int. Cl. H01T 13/46; F23Q 3/00

(52) U.S. Cl. CPC H01T 13/465; F23Q 3/008

(57) ABSTRACT

A system includes an igniter rod having a ground rod with a first tip bent at a 90-degree angle, an internal rod with a second tip, a rod cover enclosing a portion of the internal rod, and a base tube, fixed to an external surface of the rod cover, enclosing a portion of the ground rod. The base tube has a plurality of adjustment screws that hold in place and position the ground rod. The igniter system further includes an igniter body configured to enclose a portion of the igniter rod and a fuel supply. The fuel supply is configured to be brought into contact with a gap between the first tip and the second tip.

### BACKGROUND

Igniters are devices that produce a specific level of heat in order for a larger combustion reaction to occur. A common igniter set up requires a continuous spark to be produced such that the combustion reaction, or flame, that is created can be controlled by the addition and removal of a fuel source from the spark's path. Conventionally, the spark is created by energizing an ignition rod and placing the energized ignition rod within a set distance to a grounded rod or plate.

The electrical difference between the energized ignition rod and the grounded plate creates a continuous spark. However, this method is often unreliable, and the spark dissipates due to lack of adjustment, loose rod tips, and debris. When the spark dissipates, the apparatus may need to be disassembled to deduce and solve the problem. This causes inefficiency in operations and, as such, a method that allows for a sustained spark to be produced is beneficial.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure presents, in one or more embodiments, an igniter rod apparatus, an igniter system, and a method for operating the igniter system. The igniter rod apparatus includes a ground rod having a first tip bent at a 90-degree angle, an internal rod having a second tip, a rod cover enclosing a portion of the internal rod, and a base tube, fixed to an external surface of the rod cover, enclosing a portion of the ground rod. The base tube has a plurality of adjustment screws that hold in place and position the ground rod.

In one or more embodiments, the igniter system includes an igniter rod having a ground rod with a first tip bent at a 90-degree angle, an internal rod with a second tip, a rod cover enclosing a portion of the internal rod, and a base tube, fixed to an external surface of the rod cover, enclosing a portion of the ground rod. The base tube has a plurality of adjustment screws that hold in place and position the ground rod. The igniter system further includes an igniter body configured to enclose a portion of the igniter rod and a fuel supply. The fuel supply is configured to be brought into contact with a gap between the first tip and the second tip.

In further embodiments, a method for operating the igniter system includes inserting a ground rod, with a first tip bent at a 90-degree angle, into a base tube having a plurality of adjustment screws. Adjusting the adjustment screws to move and hold the ground rod in relation to an internal rod, partially enclosed by a rod cover, to create a gap of a particular size between the first tip and a second tip of the internal rod. Producing a spark within the gap between the first tip and the second tip. Providing a fuel supply to the spark to ignite the fuel supply and produce a flame out of a lateral end of an igniter body. The base tube is fixed to an external surface of the rod cover and at least a portion of the rod cover and the base tube are located within the igniter body such that the spark created between the first tip and the second tip is located within a fuel supply flow path within the igniter body.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an apparatus in accordance with one or more embodiments.

FIG. 2 shows an apparatus deployed in an igniter system in accordance with one or more embodiments.

FIG. 3 shows a flowchart in accordance with one or more embodiments.

FIG. 4 shows an apparatus deployed in a flare stack in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Conventional electrical igniter rods are primarily comprised of an internal rod connected to a power source. A portion of the internal rod is housed by an electrical insulating rod cover, and a portion of the rod cover is housed in a conductive rod housing. The igniter rod becomes energized when energy is transferred from the power source to the internal rod. In order for a spark to be produced, a grounded, or non-energized, conductive material is placed within a certain distance to the internal rod. The energy difference between the two materials causes the spark to be produced.

Often, the igniter rod, as described above, is a part of a larger igniter system comprising a fuel supply and an igniter body. The igniter body is used as the grounded, or non-energized, conductive material that is used to create the spark with the internal rod. The fuel supply is configured to interact with the spark and produce a larger combustion reaction, or flame. The igniter rod's position is adjusted within the igniter body by body adjustment screws. The body adjustment screws allow the distance between the internal rod and the igniter body to be adjusted to the distance required to create the spark. However, these body adjustment screws are loose and do not provide the accuracy needed to ensure a spark. There is also no consistency as to where the spark is produced with this design as the spark could be produced anywhere between the internal rod and the igniter body. The ability to accurately adjust the internal rod and produce a spark at a known position is beneficial for ensuring a sustained spark.

Accordingly, embodiments disclosed herein provide an igniter with the purpose of enhancing the spark on the ignition process, by having an adjustable ground rod which ensures the ignitions efficiency at all times, rather than relying on the pipe (outer layer of the igniters) which may cause the spark or not.

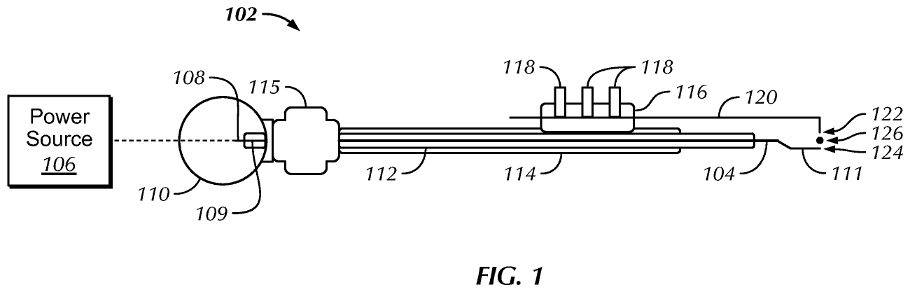

FIG. 1 shows a proposed igniter rod (102) apparatus in accordance with one or more embodiments. The igniter rod (102) is primarily comprised of an internal rod (104) connected to a power source (106) by an electrical connection (108). The internal rod (104) is made of any suitable conductive material that is able to tolerate high temperatures and rust such as stainless steel. The internal rod (104) comprises a first lateral end (109) extending laterally from a second lateral end (111). The second lateral end (111) comprises a second tip (124). In one or more embodiments, the internal rod (104) may be made of stainless steel (SS 446) and may extend 6 cm-6.5 cm from a lateral end of the rod housing (112). The length that the internal rod (104) may extend from the lateral end of the rod housing (112) is proportional to the size of the igniter rod (102) apparatus and may be less than or greater than the aforementioned range of 6 cm-6.5 cm. The first lateral end (109) of the internal rod (104) is housed in a wiring box (110) and an electrical connection (108) may be located within the wiring box (110) where the first lateral end (109) of the internal rod (104) connects to the power source (106).

The power source (106) may be a DC power supply, such as a battery, or an AC power supply, such as an outlet. The wiring box (110) may be made of any material that is able to tolerate high temperatures and rust such as stainless steel. The wiring box (110) may be any three-dimensional shape, such as a sphere or cube, that has an internal cavity with the ability to house the electrical connection (108) and the first lateral end (109) of the internal rod (104).

A portion of the internal rod (104) is housed by a rod housing (112). The rod housing (112) covers a portion of the internal rod (104) such that the second lateral end (111) of the internal rod (104) is exposed. The rod housing (112) may be made of any non-conductive material, such as ceramic, that is able to tolerate high temperatures. The rod housing (112) may be any three-dimensional shape, such as a cylinder, that has an internal cavity with the ability to house the portion of the internal rod (104). A portion of the rod housing (112) may also be housed in the wiring box (110).

In one or more embodiments, the rod housing (112) is housed in a rod cover (114) such that either the entirety of the rod housing (112) is encompassed within the rod cover (114), or a portion of the rod housing (112) is encompassed by the rod cover (114) as depicted in FIG. 1. When the entirety of the rod housing (112) is housed by the rod cover (114), the second lateral end (111) of the internal rod (104) is still exposed. The rod cover (114) may be made of any material that is able to tolerate high temperatures and rust such as stainless steel.

The rod cover (114) may be any three-dimensional shape, such as a cylinder, that has an internal cavity with the ability to house the rod housing (112). The rod cover (114) shape may or may not match the 3D shape of the rod housing (112). The rod cover (114) may be connected to the wiring box (110) by a fitting (115). The fitting (115) may be made of any material, such as silicone rubber or stainless steel, that can tolerate high temperatures. The fitting may (115) may be any device or mechanism, such as a coupling, that may fix the rod cover (114) to the wiring box (110).

In one or more embodiments, a base tube (116) is fixed to an external surface of the rod cover (114). The base tube (116) may be fixed onto the rod cover (114) by any method or device such as welding or brackets. The base tube (116) may be made of any material that is able to tolerate high temperatures and rust such as stainless steel. The base tube (116) may be any three-dimensional shape, such as a cylinder, that has an internal cavity with the ability to house a plurality of adjustment screws (118) and a portion of a ground rod (120). In one or more embodiments, the base tube (116) may be made of stainless steel (SS 310) and may be in a cylindrical shape with a diameter of 0.5 inch and a length of 7 cm. In other embodiments, the base tube (116) may be 7 cm-9 cm, however the base tube is proportional to the size of the igniter rod (102) apparatus and may be less than or greater than the aforementioned range of 7 cm-9 cm.

The ground rod (120) is a separate entity from the internal rod (104) and is made of any conductive material that is able to tolerate high temperatures and rust such as stainless steel. In one or more embodiments, the ground rod (120) may be made of stainless steel (SS 430) and may extend to reach the second tip (124) of the internal rod (104). The adjustment screws (118) hold in place and position the ground rod (120). The adjustment screws (118) are adjusted to move the ground rod (120) horizontally and vertically with respect to the internal rod (104). In one or more embodiments, the range of movement allowed by adjusting the adjustment screws (118) is 1 mm. Those skilled in the art will appreciate that other tools, such as sliding pins or bolts, that provide the same functionality described above may be used in place of the adjustment screws (118). The adjustment screws (118) may be made of any material that is able to tolerate high temperatures such as carbon steel. More specifically, in one or more embodiments, there may be three adjustment screws (118) made of carbon steel measuring 0.25 inch in diameter. Those of ordinary skill in the art will appreciate that there may be any number of adjustment screws used in the ignitor apparatus of FIG. 1, and that although FIG. 1 shows three adjustment screws, there may be any suitable number present (e.g., two, four, etc.) that may be used to adjust the ground rod (120).

In one or more embodiments, the ground rod (120) comprises a first tip (122) bent at an angle from a central axis of the ground rod (120). In further embodiments, the first tip (122) is bent at a 90-degree angle from the central axis of the ground rod (120). The first tip (122) may be directed towards the second tip (124) of the internal rod (104). The second tip (124) may be bent at any angle or the second tip (124) may be straight. In one or more embodiments, the first tip (122) of the ground rod (120) extends laterally to the second tip (124) of the internal rod (104) leaving a gap between the two tips, in which a spark (126) may be produced.

The spark (126) is produced by an energy difference created between an energized internal rod (104) and a grounded ground rod (120). The internal rod (104) is energized by transferring energy from the power source (106) to the internal rod (104). The ground rod (120) has no energy passing through it. The production of the spark (126) may depend on when a predetermined distance is reached within the gap between the first tip (122) and the second tip (124).

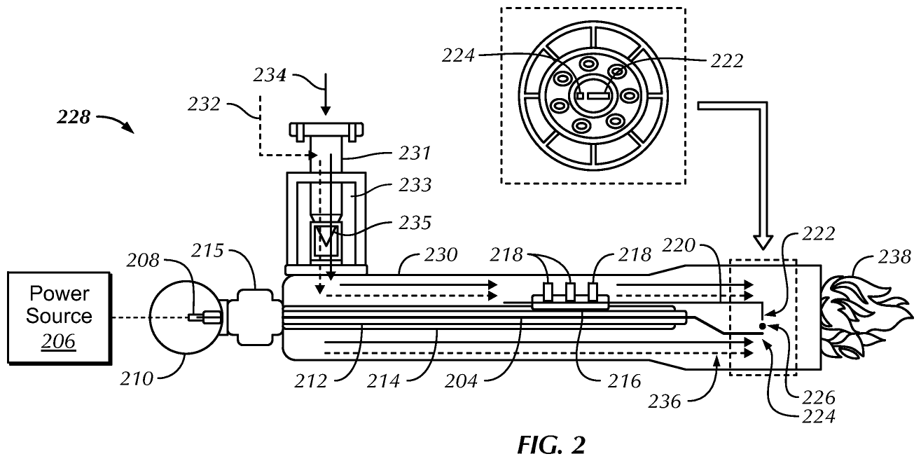

FIG. 2 shows an igniter system (228) in accordance with one or more embodiments. More specifically, FIG. 2 shows the igniter rod (102) of FIG. 1 as part of a larger system with an igniter body (230) and a fuel supply system (231). Elements of FIG. 2 that are identical to FIG. 1 are not re-described for purposes of readability, and have the same functions described above. The igniter system (228) is comprised of at least a portion of the igniter rod (102), as described above in FIG. 1, housed in the igniter body (230). The igniter body (230) may be made of any material that is resistant to high temperatures and rust such as stainless steel. The fitting (215) may allow for the igniter rod (102) to be connected to the igniter body (230) as depicted in FIG. 2.

The igniter body (230) is connected to the fuel supply system (231) having a path for air flow (232) and a path for gasoline flow (234). The air flow (232) and the gasoline flow (234) enter the igniter body (230) through the fuel supply system (231). The fuel supply system (231) has an air production cup (233) which allows for the addition of the air to the system, and a fuel nozzle (235) which is where the gasoline exits and is mixed with the air. The mixture of air and gasoline follow the air flow (232) path and the gasoline flow (234) path through the igniter body (230) to a location where the spark (226) is produced. The amount of air flow (232) may be controlled by an air valve that may be connected to the air production cup (233), and the gasoline flow (234) may be controlled by a gasoline valve that may be connected to the fuel nozzle (235). As the mixture of air flow (232) and gasoline flow (234) intersect the spark (226), a larger combustion reaction creating a flame (238) occurs. The flame (238) is expelled out of a lateral end of the igniter body (230).

The spark (226) is produced by an energy difference created between an energized internal rod (204) and a grounded ground rod (220). The internal rod (204) is energized by transferring energy from the power source (206) to the internal rod (204). The ground rod (220) has no energy passing though. The production of the spark (226) may depend on when a set distance within the gap between the first tip (222) and the second tip (224) is reached. In the igniter system (228) setup, while the power source (206) is turned on and connected, the spark (226) is consistent while the production of the flame (238) and the size of the flame (238) is controlled by the addition and reduction of air flow (232) and gasoline flow (234). The igniter system (228) as depicted in FIG. 2 may be used in any scenario where a constant spark is required such as in a sulfur recovery plants or in a flare stack. The igniter system (228) may be used in a furnace that burns CO₂ at high temperatures in a sulfur recovery plant. The furnace may contain 8 burners with each burner having an individual igniter system (228).

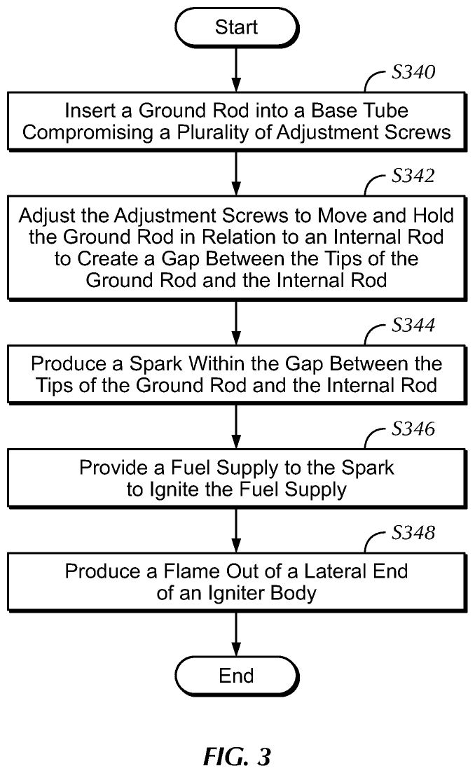

FIG. 3 shows a flowchart depicting a method for using the igniter system (228) described in FIG. 2. One or more blocks of FIG. 3 may be performed using one or more components as described in FIGS. 1 and 2. While the various blocks in FIG. 3 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Step S340, a ground rod (120, 220) is inserted into a base tube (116, 216) comprising a plurality of adjustment screws (118, 218). A first tip (122, 222) of the ground rod (120, 220) may be touching the second tip (124, 224) of the internal rod (104, 204) or there may be a gap between the first tip (122, 222) and the second tip (124, 224). The base tube (116, 216) is installed on the rod cover (114, 214) housing the rod housing (112, 212) and the internal rod (104, 204) as described in FIG. 1. The ground rod (120, 220) comprises a first tip (122, 222) bent at 90 degrees and the internal rod (104, 204) comprises a second tip (124, 224) distinct from the first tip of the ground rod.

In Step S342, the adjustment screws (118, 218) are adjusted to move and hold the ground rod (120, 220) in relation to the internal rod (104, 204) to adjust the size of the gap between the tips of the ground rod (120, 220) and the internal rod (104, 204). In one or more embodiments, the size of the gap that is required to produce a spark between the two rods is between 2 mm and 3.5 mm. The adjustment screws may be loosened or tightened in a clockwise or counterclockwise direction, dependent on their design, to move and hold the ground rod (120, 220) a predetermined distance away from the internal rod to create the gap. The internal rod (104, 204) is connected to a power source (106, 206) by an electrical connection (108, 208) located within a wiring box (110, 210). When the power source (106, 206) is turned on, in Step S344, the internal rod (104, 204) is energized to produce a spark (126, 226) within the gap located between the first tip (122, 222) of the ground rod (120, 220) and the second tip (124, 224) of the internal rod (104, 204).

A fuel supply is provided to the spark (126, 226) by bringing the fuel supply within close proximity of the spark (126, 226) such that the fuel supply is ignited (S346). The fuel supply may be brought within close proximity of the spark (126, 226) by an automated or a manual process. The igniter body (230) of the igniter system (228) is connected to the fuel supply system (231) comprising a path for air flow (232) and a path for gasoline flow (234). The air flow (232) and the gasoline flow (234) enter the igniter body (230) in the fuel supply flow path (236) which is located at the location the spark (126, 226) is produced.

The amount of air flow (232) may be controlled by an air valve and the gasoline flow (234) may be controlled by a gasoline valve. As the mixture of air flow (232) and gasoline flow (234) intersect the spark (126, 226) a larger combustion reaction creating a flame (238) occurs. The flame (238) is expelled out of a lateral end of the igniter body (230) (S348). The production of the flame (238) and the size of the flame (238) is controlled by the addition and reduction of air flow (232) and gasoline flow (234).

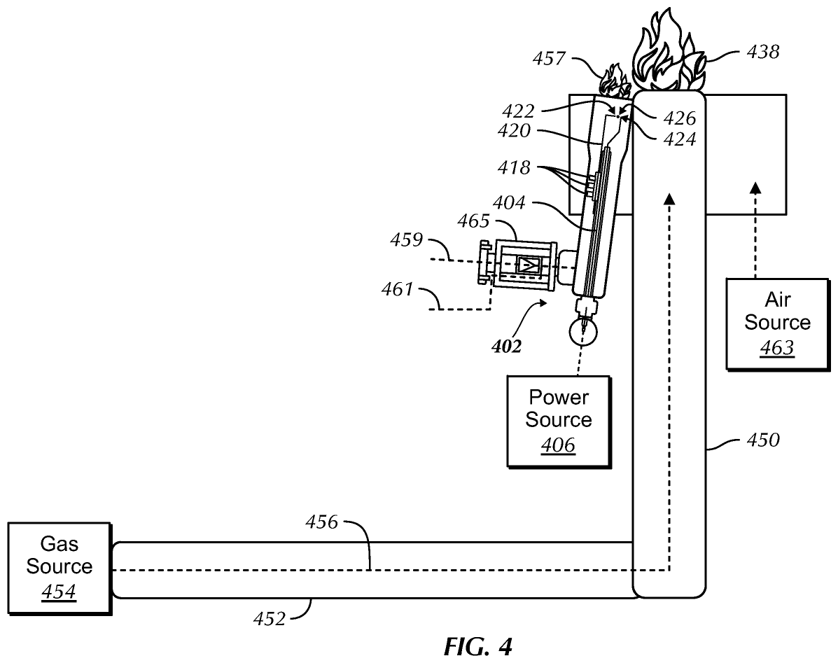

FIG. 4 shows the igniter rod (402), as described in FIG. 1, deployed in a flare stack (450). In certain industries, unwanted gas, including but not limited to natural gas, H₂S, sulfur, etc., is produced or created. For example, in some drilling operations, associated gas from a formation is introduced to a mud circulating system. This gas needs to be removed from the circulating system and a method to do so is to burn off, or flare, the unwanted gas in a flare stack (450). In certain refining operations, amounts of unwanted gas may be produced and this gas is also flared in flare stacks (450). FIG. 4 shows one example of a practical application of the igniter rod (102) of FIG. 1; however, those of ordinary skill in the art will appreciate that the invention is not limited to the application of FIG. 4 and may be used in any suitable scenario where a constant spark is desired such as in a furnace in a sulfur recovery plant.

This gas to be flared is depicted as the gas source (454) in FIG. 4. This gas source (454) may be from a wellbore or a refining system as described previously, or this gas may be any gas that is going to be flared in the flare stack (450). The gas flows along a gas flow path (456) from the gas source (454) through a pipeline (452) to the flare stack (450). An air source (463) may also enter the flare stack (450) to provide oxygen for ignition of the gas source (454). The air source (463) may be air from the atmosphere. The pipeline (452) may be made of any material that may tolerate high pressures and temperatures. The pipeline (452) may be formed in a cylindrical shape of varying diameters.

The flare stack (450) may be made of any material that may tolerate high pressures and temperatures. Flare stacks (450) are commonly vertical and formed in a cylindrical shape, however, any conduit that may bring the gas to the igniter rod (402) may be used without departing from the scope of this disclosure. The igniter rod (402) is connected to a power source (406). The power source (406) may be a DC power supply, such as a battery, or an AC power supply, such as an outlet. The power source (406) energizes the internal rod (404).

A spark (426) is produced by an energy difference created between the energized internal rod (404) and a grounded ground rod (420). The ground rod (420) is able to be adjusted with relation to the internal rod (404) by adjusting the adjustable screws (418). The ground rod (420) comprises a first tip (422) that is bent at a 90-degree angle with respect to a central axis of the ground rod (420). The internal rod (404) comprises a second tip (424) that may or may not be bent. The first tip (422) of the ground rod (420) extends laterally to the second tip (424) of the internal rod (404) leaving a gap in which the spark (426) is produced.

The igniter rod (402) may be connected to a pilot fuel supply system (465), similar to the fuel supply system (231) described in FIG. 2, to produce a pilot flame (457). The pilot flame (457) may be a smaller flame used to produce an even larger flame (438) out of the flare stack (450). The pilot fuel supply system (465) may comprise a pilot air source (402) that may be the atmosphere and a pilot gas source (459) that may be gasoline. The spark (426) may be ignited by the addition of the gasoline from the pilot gas source (459) and the air from the pilot air source (461) to create the pilot flame (457). As the unwanted gas from the gas source (454) flows along the gas flow path (456) and intersects the pilot flame (457) a larger combustion reaction occurs, and a larger flame (438) is created to burn off the unwanted gas.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. An igniter rod apparatus comprising:
a ground rod comprising a first tip bent at a 90-degree angle;
an internal rod comprising a second tip;
a rod cover enclosing a portion of the internal rod; and
a base tube, fixed to an external surface of the rod cover, enclosing a portion of the ground rod;
wherein the base tube comprises a plurality of adjustment screws that hold in place and position the ground rod.

2. The apparatus of claim 1, further comprising:
a plurality of adjustment screws located within the base tube, wherein the plurality of adjustment screws are adjusted to move the ground rod horizontally and vertically with respect to the internal rod.

3. The apparatus of claim 1,
wherein the rod cover further comprises a rod housing in which a portion of the rod housing is located within the rod cover and a portion of the internal rod is located within the rod housing.

4. The apparatus of claim 1,
wherein adjustment of the plurality of adjustment screws results in the first tip of the ground rod extending laterally to the second tip of the internal rod, leaving a gap between the first and second tips.

5. The apparatus of claim 4, further comprising:
a power source;
a wiring box; and
an electrical connection,
wherein a first lateral end of the internal rod is housed in the wiring box, and the electrical connection is a location where the first lateral end of the internal rod connects to the power source.

6. The apparatus of claim 5,
wherein the internal rod is energized by transferring energy from the power source to the internal rod and a spark is produced between the first tip and the second tip by way of the energized internal rod and the ground rod, when a predetermined distance between the first tip and the second tip is reached.

7. A system comprising:
an igniter rod comprising:
a ground rod comprising a first tip bent at a 90-degree angle;
an internal rod comprising a second tip;
a rod cover enclosing a portion of the internal rod; and
a base tube, fixed to an external surface of the rod cover, enclosing a portion of the ground rod;
wherein the base tube comprises a plurality of adjustment screws that hold in place and position the ground rod.
an igniter body configured to enclose a portion of the igniter rod; and
a fuel supply,
wherein the fuel supply is configured to be brought into contact with a gap between the first tip and the second tip.

8. The system of claim 7, further comprising a plurality of adjustment screws located within the base tube, wherein the plurality of adjustment screws are adjusted to move the ground rod horizontally and vertically with respect to the internal rod.

9. The system of claim 7,
wherein the rod cover further comprises a rod housing in which a portion of the rod housing is located within the rod cover and a portion of the internal rod is located within the rod housing.

10. The system of claim 7,
wherein the igniter rod further comprises a fitting that connects the igniter rod to the igniter body.

11. The system of claim 7,
wherein the fuel supply further comprises an amount of air and an amount of gasoline where the amount of air is adjusted by an air valve and the amount of gasoline is adjusted by a gasoline valve.

12. The system of claim 11,
wherein adjustment of the plurality of adjustment screws results in the first tip of the ground rod extending laterally to the second tip of the internal rod leaving the gap in which a spark is produced, and the amount of gasoline and the amount of air is increased to be ignited by the spark and produce a flame out of a lateral end of the igniter body.

13. The system of claim 12, further comprising:
a power source;
a wiring box; and
an electrical connection,
wherein a first lateral end of the internal rod is housed in the wiring box, and the electrical connection is a location where the first lateral end of the internal rod connects to the power source.

14. The system of claim 13,
wherein the internal rod is energized by transferring energy from the power source to the internal rod and the spark is produced between the first tip and the second tip by way of the energized internal rod and the ground rod, when a predetermined distance between the first tip and the second tip is reached.

15. A method comprising:
inserting a ground rod, comprising a first tip bent at a 90-degree angle, into a base tube comprising a plurality of adjustment screws;
adjusting the adjustment screws to move and hold the ground rod in relation to an internal rod, partially enclosed by a rod cover, to create a gap of a particular size between the first tip and a second tip of the internal rod;
producing a spark within the gap between the first tip and the second tip;
providing a fuel supply to the spark to ignite the fuel supply; and
producing a flame out of a lateral end of an igniter body,
wherein the base tube is fixed to an external surface of the rod cover and at least a portion of the rod cover and the base tube are located within the igniter body such that the spark created between the first tip and the second tip is located within a fuel supply flow path within the igniter body.

16. The method of claim 15 further comprising:
a plurality of adjustment screws located within the base tube, wherein the plurality of adjustment screws are adjusted to move the ground rod horizontally and vertically with respect to the internal rod.

17. The method of claim 15,
wherein the rod cover further comprises a rod housing in which a portion of the rod housing is located within the rod cover and a portion of the internal rod is located within the rod housing.

18. The method of claim 15,
wherein the fuel supply further comprises an amount of air and an amount of gasoline where the amount of air is adjusted by an air valve and the amount of gasoline is adjusted by a gasoline valve.

19. The method of claim 15, further comprising:
a power source;
a wiring box; and
an electrical connection,
wherein a first lateral end of the internal rod is housed in the wiring box, and the electrical connection is a location where the first lateral end of the internal rod connects to the power source.

20. The method of claim 19,
wherein the internal rod is energized by transferring energy from the power source to the internal rod and the spark is produced between the first tip and the second tip by way of the energized internal rod and the ground rod, when a predetermined distance between the first tip and the second tip is reached.
